(19) United States
(12) Patent Application Publication
(10) Pub. No.: US 2018/0007258 A1
(43) Pub. Date: Jan. 4, 2018

(54) EXTERNAL IMAGING SYSTEM, EXTERNAL IMAGING METHOD, EXTERNAL IMAGING PROGRAM

(71) Applicant: FOVE, INC., San Mateo, CA (US)

(72) Inventor: Keiichi Seko, Tokyo (JP)

(21) Appl. No.: 15/635,651

(22) Filed: Jun. 28, 2017

(30) Foreign Application Priority Data
Jun. 29, 2016 (JP) 2016-129177

(51) Int. Cl. H04N 5/232; H04N 5/77

(52) U.S. Cl. CPC H04N 5/23219; H04N 5/77; H04N 5/23296; H04N 5/23203; H04N 5/23212; H04N 5/23293

(57) ABSTRACT

An external imaging system for performing imaging by easily operating an external imaging camera is provided. In the external imaging system including a head mounted display and a gaze detection device, the head mounted display includes an imaging unit that captures an image including an eye of a user being irradiated with invisible light on the basis of the invisible light, a first transmission unit that transmits the captured image and capturing time information indicating a capturing time thereof, a first reception unit that receives information on gaze directions of the user, a display unit that displays an image based on a captured video, and a control unit that controls the external imaging camera, the gaze detection device includes a gaze detection unit that detects the gaze direction of the user from the captured image and the capturing time information, and a second transmission unit that transmits information on the detected gaze direction in association with the capturing time thereof, and the control unit controls the external imaging camera on the basis of a gaze time of the user related to a gaze position.

### BACKGROUND OF THE INVENTION

### Field of the Invention

The present invention relates to an external imaging system, an external imaging method thereof, and an external imaging program, and more particularly, to a video display technology using a head mounted display.

### Description of Related Art

Conventionally, an external imaging system using a wearable terminal that is mounted on the head for use such as a head mounted display has been developed.

As an example of such a head mounted display, Japanese Unexamined Patent Application Publication No. 2002-32212 discloses a technology in which a video camera is attached to be rotatable in up-down and left-right directions by a gear motor and a capturing direction of the video camera is changed on the basis of a gaze direction of a user in a headset type display device (for example, refer to Japanese Unexamined Patent Application Publication No. 2002-32212).

### SUMMARY OF THE INVENTION

However, in Japanese Unexamined Patent Application Publication No. 2002-32212, although the capturing direction of the video camera can be changed on the basis of a gaze direction, there is a problem that capturing is uniform.

The present invention has been made in consideration of the above problem, and an object thereof is to provide an external imaging system with high usability by a camera for imaging the outside attached to a head mounted display, an external imaging method, and an external imaging program.

According to an aspect of the present invention, an external imaging system is an external imaging system including a head mounted display and a gaze detection device, wherein the head mounted display includes an irradiation unit that irradiates an eye of a user with invisible light, an imaging unit that captures an image including the eye of the user being irradiated by the irradiation unit on the basis of the invisible light, a first transmission unit that transmits a captured image captured by the imaging unit and capturing time information indicating a capturing time at which the captured image is captured to the gaze detection device, a first reception unit that receives information on gaze directions of the user from the gaze detection device, a connection unit that connects with an external imaging camera, a display unit that displays an image based on a video captured by the external imaging camera, and a control unit that controls the external imaging camera, the gaze detection device includes a second reception unit that receives the captured image and the capturing time information, a gaze detection unit that analyzes the captured image to detect the gaze direction of the user, and a second transmission unit that transmits information on the detected gaze direction to the head mounted display in association with the capturing time of the captured image used in detecting the gaze direction, and the control unit performs control of imaging by the external imaging camera on the basis of information on a plurality of gaze directions and a gaze time of the user calculated from the capturing time associated with the gaze direction.

In the external imaging system, when gazing at a specific object displayed on the display unit for a predetermined time t1 or more is detected, the control unit may control the external imaging camera to focus on the specific object.

In the external imaging system, when gazing at a specific object displayed on the display unit for a predetermined time t2 or more is detected, the control unit may control the external imaging camera to zoom in on the specific object.

The external imaging system may further include a recording unit that records a video captured by the external imaging camera when gazing at a specific object displayed on the display unit for a predetermined time t3 or more is detected.

In the external imaging system, when a gaze direction indicated by the information on gaze directions is further away from a specific object, the control unit may control the external imaging camera to zoom out from the specific object.

The external imaging system may further include a generation unit that generates a still image on the basis of a video captured by the external imaging camera when the user closing his or her eyelid twice within a predetermined time is detected from the video captured by the imaging unit.

According to an aspect of the present invention, an external imaging method is an external imaging method in which an external video is captured by an external imaging system including a head mounted display to which an external imaging camera for imaging the outside is detachably connected and a gaze detection device and includes a displaying step of displaying an image based on a video captured by the external imaging camera on a display unit, an irradiating step in which the head mounted display irradiates an eye of a user with invisible light, an imaging step in which the head mounted display captures an image including the eye of the user being irradiated with the invisible light on the basis of the invisible light, a first transmitting step of transmitting a captured image captured by the head mounted display and capturing time information indicating a capturing time at which the captured image is captured to the gaze detection device, a first receiving step in which the gaze detection device receives the captured image and the capturing time information, a gaze detecting step in which the gaze detection device analyzes the captured image to detect a gaze direction of the user, a second transmitting step in which the gaze detection device transmits information on the detected gaze direction to the head mounted display in association with the capturing time of the captured image used in detecting the gaze direction, and a controlling step in which the head mounted display performs control of imaging by the external imaging camera on the basis of information on a plurality of gaze directions and a gaze time of the user calculated from the capturing time associated with the gaze direction.

According to an aspect of the present invention, an external imaging program is an external imaging program for capturing an external video by a head mounted display in an external imaging system including the head mounted display to which an external imaging camera for imaging the outside is detachably connected and a gaze detection device and allows a computer to execute a displaying function of displaying an image based on a video captured by the external imaging camera on a display unit, an irradiating function in which the head mounted display irradiates an eye of a user with invisible light, an imaging function of imaging an image including the eye of the user being irradiated with the invisible light on the basis of the invisible light, a transmitting function of transmitting the captured image and capturing time information indicating a capturing time at which the captured image is captured to the gaze detection device, a receiving function of receiving, from the gaze detection device, information on gaze directions detected by the gaze detection device on the basis of the captured image and the capturing time at which the image used in the detection is captured, and a controlling function of performing control of imaging by the external imaging camera on the basis of information on a plurality of gaze directions and a gaze time of the user calculated from the capturing time associated with the gaze direction.

According to the present invention, an external imaging system can perform various imaging by controlling an external imaging camera connected to a head mounted display on the basis of a gaze direction of a user wearing the head mounted display.

### BRIEF DESCRIPTION OF THE DRAWINGS

FIG. 1 is an external view illustrating a state in which a user wears a head mounted display according to an embodiment;

FIG. 2 is a perspective view schematically illustrating an overview of an image display system of the head mounted display according to the embodiment;

FIG. 3 is a diagram schematically illustrating an optical configuration of an image display system of the head mounted display according to the embodiment;

FIG. 4 is a block diagram illustrating a configuration of an external imaging system according to the embodiment;

FIG. 5 is a schematic diagram illustrating calibration for detection of a gaze direction according to the embodiment;

FIG. 6 is a schematic diagram illustrating position coordinates of a cornea of a user;

FIG. 7 is a flowchart illustrating an operation of the external imaging system according to the embodiment;

FIG. 8 is a block diagram illustrating a circuit configuration of the external imaging system.

### DETAILED DESCRIPTION OF THE INVENTION

### Embodiment

<Configuration>

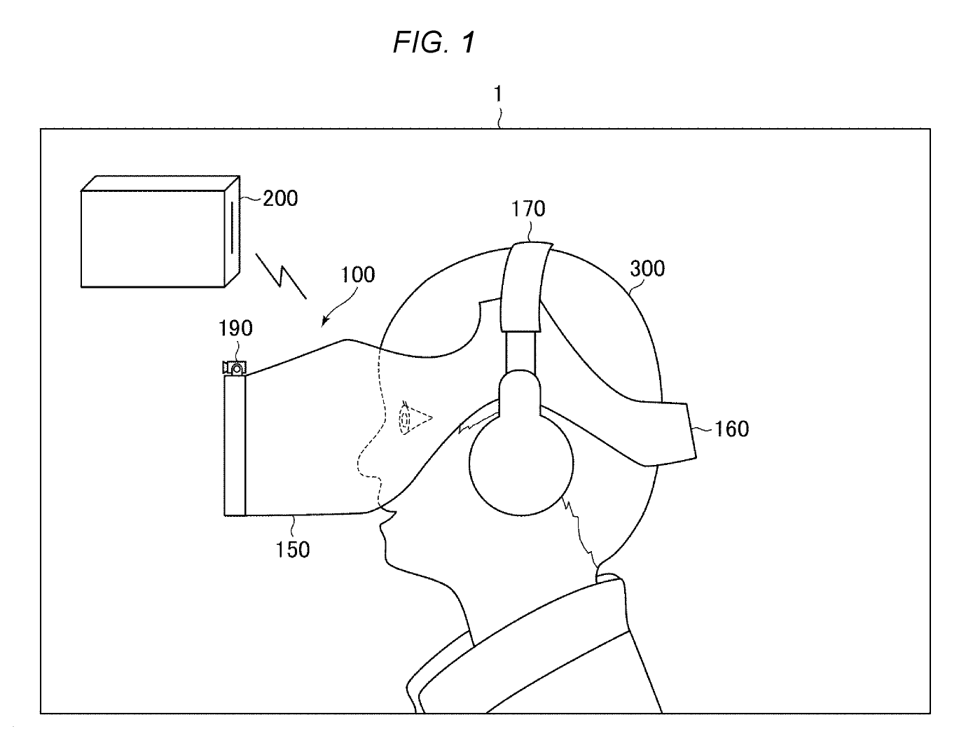

FIG. 1 is a view schematically illustrating an overview of an external imaging system 1 according to an embodiment. The external imaging system 1 according to the embodiment includes a head mounted display 100 and a gaze detection device 200. As illustrated in FIG. 1, the head mounted display 100 is mounted on the head of a user 300 for use.

The gaze detection device 200 detects a gaze direction of at least one of a right eye and a left eye of the user wearing the head mounted display 100 and specifies the user's focal point, i.e., a point gazed by the user in a three-dimensional image displayed on the head mounted display. The gaze detection device 200 also functions as a video generation device that generates a video to be displayed by the head mounted display 100. For example, the gaze detection device 200 is a device capable of reproducing videos of stationary game machines, portable game machines, PCs, tablets, smartphones, phablets, video players, TVs, or the like, but the present invention is not limited thereto. The gaze detection device 200 is wirelessly or wiredly connected to the head mounted display 100. In the example illustrated in FIG. 1, the gaze detection device 200 is wirelessly connected to the head mounted display 100. The wireless connection between the gaze detection device 200 and the head mounted display 100 can be realized using a known wireless communication technique such as Wi-Fi® or Bluetooth®. For example, transfer of videos between the head mounted display 100 and the gaze detection device 200 is executed according to a standard such as Miracast®, WiGig®, or WHDI®.

FIG. 1 illustrates an example in which the head mounted display 100 and the gaze detection device 200 are different devices. However, the gaze detection device 200 may be built into the head mounted display 100.

The head mounted display 100 includes a housing 150, a fitting harness 160, headphones 170, and an external imaging camera 190. The housing 150 houses an image display system, such as an image display element, for presenting videos to the user 300, and a wireless transfer module (not illustrated) such as a Wi-Fi module or a Bluetooth® module. The fitting harness 160 is used to mount the head mounted display 100 on the head of the user 300. The fitting harness 160 may be realized by, for example, a belt or an elastic band. When the user 300 wears the head mounted display 100 using the fitting harness 160, the housing 150 is arranged at a position where the eyes of the user 300 are covered. Thus, if the user 300 wears the head mounted display 100, a field of view of the user 300 is covered by the housing 150. The external imaging camera 190 is attached to the head mounted display 100 to capture an outside state which cannot be directly viewed by the user wearing the head mounted display 100. The external imaging camera 190 can be detachably attached to the head mounted display 100. When the external imaging camera 190 is attached to the head mounted display 100, the external imaging camera 190 is electrically connected to a control system of the head mounted display 100 such that a video captured by the external imaging camera 190 can be transferred to head mounted display 100, and the external imaging camera 190 receives control from the head mounted display 100.

The headphones 170 output audio for the video that is reproduced by the gaze detection device 200. The headphones 170 may not be fixed to the head mounted display 100. Even when the user 300 wears the head mounted display 100 using the fitting harness 160, the user 300 may freely attach or detach the headphones 170.

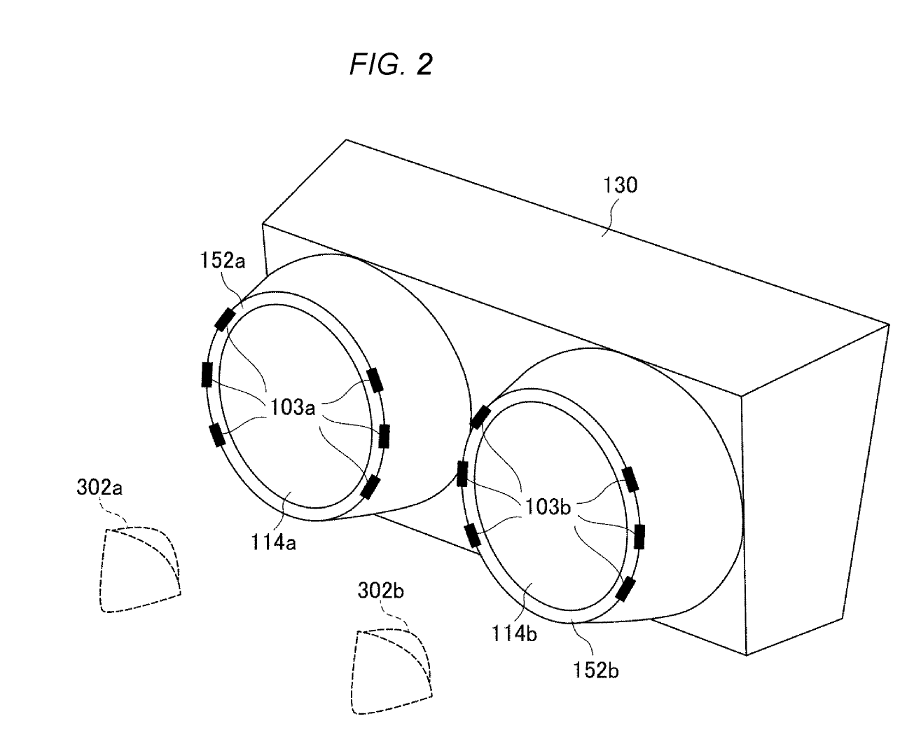

FIG. 2 is a perspective diagram illustrating an overview of the image display system 130 of the head mounted display 100 according to the embodiment. Specifically, FIG. 2 illustrates a region of the housing 150 according to an embodiment that faces corneas 302 of the user 300 when the user 300 wears the head mounted display 100.

As illustrated in FIG. 2, a convex lens 114a for the left eye is arranged at a position facing the cornea 302a of the left eye of the user 300 when the user 300 wears the head mounted display 100. Similarly, a convex lens 114b for a right eye is arranged at a position facing the cornea 302b of the right eye of the user 300 when the user 300 wears the head mounted display 100. The convex lens 114a for the left eye and the convex lens 114b for the right eye are gripped by a lens holder 152a for the left eye and a lens holder 152b for the right eye, respectively.

Hereinafter, in this specification, the convex lens 114a for the left eye and the convex lens 114b for the right eye are simply referred to as a “convex lens 114” unless the two lenses are particularly distinguished. Similarly, the cornea 302a of the left eye of the user 300 and the cornea 302b of the right eye of the user 300 are simply referred to as a “cornea 302” unless the corneas are particularly distinguished. The lens holder 152a for the left eye and the lens holder 152b for the right eye are referred to as a “lens holder 152” unless the holders are particularly distinguished.

A plurality of infrared light sources 103 are included in the lens holders 152. For the purpose of brevity, in FIG. 2, the infrared light sources that irradiate the cornea 302a of the left eye of the user 300 with infrared light are collectively referred to as infrared light sources 103a, and the infrared light sources that irradiate the cornea 302b of the right eye of the user 300 with infrared light are collectively referred to as infrared light sources 103b. Hereinafter, the infrared light sources 103a and the infrared light sources 103b are referred to as “infrared light sources 103” unless the infrared light sources 103a and the infrared light sources 103b are particularly distinguished. In the example illustrated in FIG. 2, six infrared light sources 103a are included in the lens holder 152a for the left eye. Similarly, six infrared light sources 103b are included in the lens holder 152b for the right eye. Thus, the infrared light sources 103 are not directly arranged in the convex lenses 114, but are arranged in the lens holders 152 that grip the convex lenses 114, making the attachment of the infrared light sources 103 easier. This is because machining for attaching the infrared light sources 103 is easier than for the convex lenses 114 that are made of glass or the like since the lens holders 152 are typically made of a resin or the like.

As described above, the lens holders 152 are members that grip the convex lenses 114. Therefore, the infrared light sources 103 included in the lens holders 152 are arranged around the convex lenses 114. Although there are six infrared light sources 103 that irradiate each eye with infrared light herein, the number of the infrared light sources 103 is not limited thereto. There may be at least one light source 103 for each eye, and two or more light sources 103 are desirable.

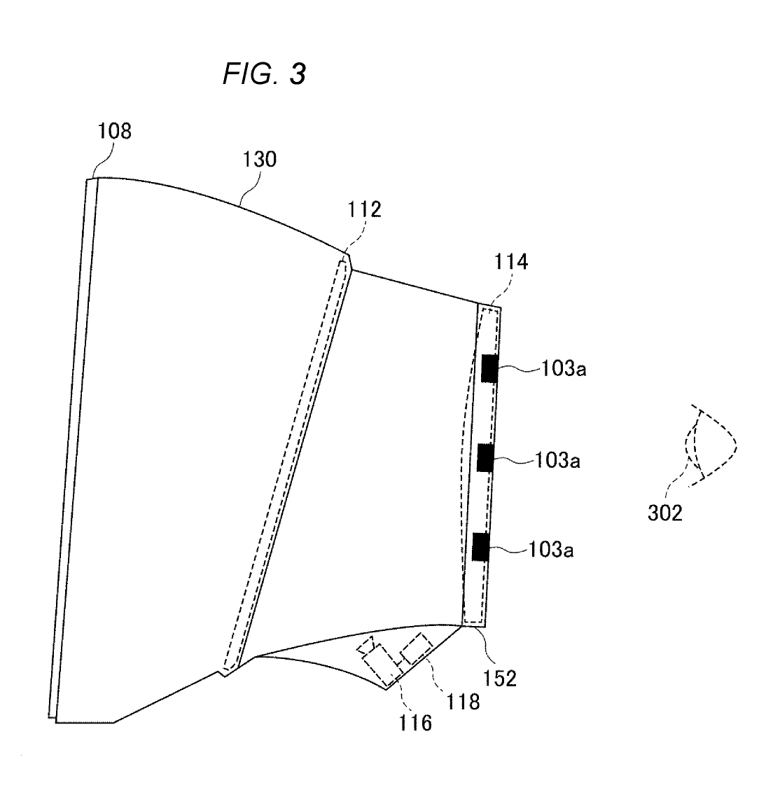

FIG. 3 is a schematic diagram of an optical configuration of the image display system 130 contained in the housing 150 according to the embodiment, and is a diagram illustrating a case in which the housing 150 illustrated in FIG. 2 is viewed from a side surface on the left eye side. The image display system 130 includes infrared light sources 103, an image display element 108, a hot mirror 112, the convex lenses 114, a camera 116, and a first communication unit 118.

The infrared light sources 103 are light sources capable of emitting light in a near-infrared wavelength region (700 nm to 2500 nm range). Near-infrared light is generally light in a wavelength region of non-visible light that cannot be observed by the naked eye of the user 300.

The image display element 108 displays an image to be presented to the user 300. The image to be displayed by the image display element 108 is generated by a video generation unit 222 in the gaze detection device 200. The video generation unit 222 will be described below. The image display element 108 can be realized by using an existing liquid crystal display (LCD), organic electro luminescence display (organic EL display), or the like.

The hot mirror 112 is arranged between the image display element 108 and the cornea 302 of the user 300 when the user 300 wears the head mounted display 100. The hot mirror 112 has a property of transmitting visible light created by the image display element 108, but reflecting near-infrared light.

The convex lenses 114 are arranged on the opposite side of the image display element 108 with respect to the hot mirror 112. In other words, the convex lenses 114 are arranged between the hot mirror 112 and the cornea 302 of the user 300 when the user 300 wears the head mounted display 100. That is, the convex lenses 114 are arranged at positions facing the corneas 302 of the user 300 when the user 300 wears the head mounted display 100.

The convex lenses 114 condense image display light that is transmitted through the hot mirror 112. Thus, the convex lenses 114 function as image magnifiers that enlarge an image created by the image display element 108 and present the image to the user 300. Although only one of each convex lens 114 is illustrated in FIG. 2 for convenience of description, the convex lenses 114 may be lens groups configured by combining various lenses or may be a plano-convex lens in which one surface has curvature and the other surface is flat.

A plurality of infrared light sources 103 are arranged around the convex lens 114. The infrared light sources 103 emit infrared light toward the cornea 302 of the user 300.

Although not illustrated in the figure, the image display system 130 of the head mounted display 100 according to the embodiment includes two image display elements 108, and can independently generate an image to be presented to the right eye of the user 300 and an image to be presented to the left eye of the user. Accordingly, the head mounted display 100 according to the embodiment may present a parallax image for the right eye and a parallax image for the left eye to the right and left eyes of the user 300. Thereby, the head mounted display 100 according to the embodiment can present a stereoscopic video that has a feeling of depth for the user 300.

As described above, the hot mirror 112 transmits visible light but reflects near-infrared light. Thus, the image light emitted by the image display element 108 is transmitted through the hot mirror 112, and reaches the cornea 302 of the user 300. The infrared light emitted from the infrared light sources 103 and reflected in a reflective area inside the convex lens 114 reaches the cornea 302 of the user 300.

The infrared light reaching the cornea 302 of the user 300 is reflected by the cornea 302 of the user 300 and is directed to the convex lens 114 again. This infrared light is transmitted through the convex lens 114 and is reflected by the hot mirror 112. The camera 116 includes a filter that blocks visible light and images the near-infrared light reflected by the hot mirror 112. That is, the camera 116 is a near-infrared camera which images the near-infrared light emitted from the infrared light sources 103 and reflected by the cornea of the eye of the user 300.

Although not illustrated in the figure, the image display system 130 of the head mounted display 100 according to the embodiment includes two cameras 116, that is, a first imaging unit that captures an image including the infrared light reflected by the right eye and a second imaging unit that captures an image including the infrared light reflected by the left eye. Thereby, images for detecting gaze directions of both the right eye and the left eye of the user 300 can be acquired.

The first communication unit 118 outputs the image captured by the camera 116 to the gaze detection device 200 that detects the gaze direction of the user 300. Specifically, the first communication unit 118 transmits the image captured by the camera 116 to the gaze detection device 200. Although the gaze detection unit 221 functioning as a gaze direction detection unit will be described below in detail, the gaze direction unit is realized by an external imaging program executed by a central processing unit (CPU) of the gaze detection device 200. When the head mounted display 100 includes computational resources such as a CPU or a memory, the CPU of the head mounted display 100 may execute the program that realizes the gaze direction detection unit.

As will be described below in detail, bright spots caused by near-infrared light reflected by the cornea 302 of the user 300 and an image of the eyes including the cornea 302 of the user 300 observed in a near-infrared wavelength region are captured in the image captured by the camera 116.

Although the configuration for presenting the image to the left eye of the user 300 in the image display system 130 according to the embodiment has mainly been described above, a configuration for presenting an image to the right eye of the user 300 is the same as above.

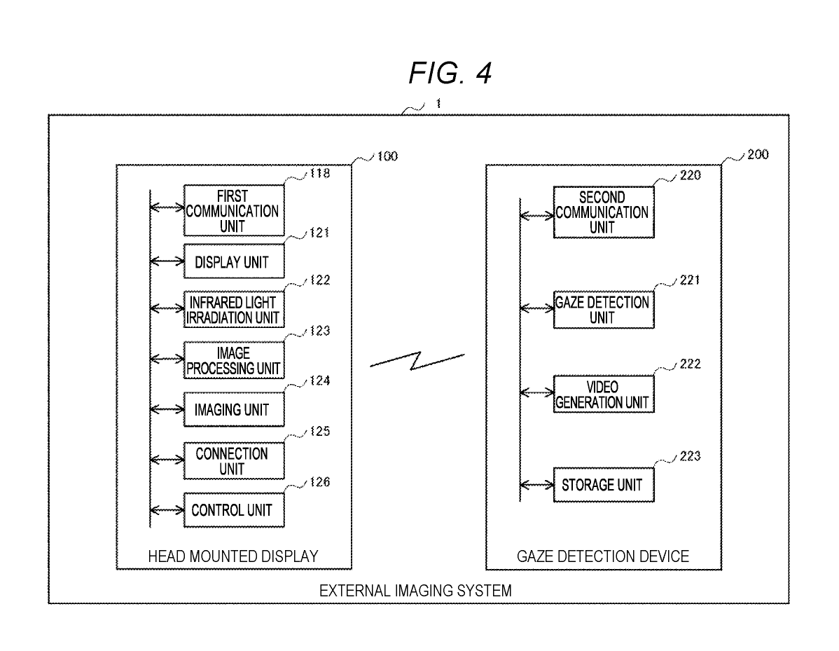

FIG. 4 is a block diagram of the head mounted display 100 and the gaze detection device 200 of the external imaging system 1. As illustrated in FIG. 4 and as described above, the external imaging system 1 includes the head mounted display 100 and the gaze detection device 200 that communicate with each other.

As illustrated in FIG. 4, the head mounted display 100 includes the first communication unit 118, a display unit 121, an infrared light irradiation unit 122, an image processing unit 123, an imaging unit 124, a connection unit 125, and a control unit 126.

The first communication unit 118 is a communication interface having a function of communicating with the second communication unit 220 of the gaze detection device 200. As described above, the first communication unit 118 communicates with the second communication unit 220 through wired or wireless communication. Examples of usable communication standards are as described above. The first communication unit 118 transmits image data to be used for gaze detection transferred from the imaging unit 124 or the image processing unit 123 to the second communication unit 220. The first communication unit 118 transfers image data or a marker image transmitted from the gaze detection device 200 to the display unit 121. The image data is, for example, a video captured by the external imaging camera 190. The image data may also be a pair of parallax images including a parallax image for the right eye and a parallax image for the left eye for displaying a three-dimensional image. The first communication unit 118 transfers time information related to a gaze direction transmitted from the gaze detection device 200 and capturing time information associated therewith to the control unit 126. The first communication unit 118 transfers an external video captured by the external imaging camera 190 transferred from the connection unit 125 to the gaze detection device 200.

The display unit 121 has a function of displaying image data transferred from the first communication unit 118 to the image display element 118. The display unit 121 displays an image based on a video captured by the external imaging camera 190 as image data. The image data may be an image of a video itself captured by the external imaging camera 190 or may be an image that results from adding certain image processing to the video. The display unit 121 displays a marker image output from the video generation unit 222 at designated coordinates of the image display element 108.

The infrared light irradiation unit 122 controls the infrared light sources 103 and irradiates the right eye or the left eye of the user with infrared light.

The image processing unit 123 performs image processing on the image captured by the imaging unit 124 as necessary, and transfers a processed image to the first communication unit 118.

The imaging unit 124 uses the camera 116 to capture an image including near-infrared light reflected from each eye. That is, the camera 116 performs imaging based on invisible light. Further, the imaging unit 124 captures an image including the user's eye viewing the marker image displayed on the image display element 108. The imaging unit 124 transfers the image obtained by capturing to the first communication unit 118 or the image processing unit 123 in association with a capturing time at which the image is captured.

The connection unit 125 is an interface having a function of connecting with the external imaging camera 190. Upon detecting that the external imaging camera 190 is connected thereto, the connection unit 125 transfers the fact that the external imaging camera 190 is connected thereto to the control unit 126. The connection unit 125 transfers a video captured by the external imaging camera 190 to the first communication unit 118 or the display unit 121. Further, the connection unit 125 transfers a control signal from the control unit 126 to the external imaging camera 190.

The control unit 126 generates a control signal for controlling imaging by the external imaging camera 190 on the basis of the information on gaze directions and the capturing time associated therewith transferred from the first communication unit 118 and transfers the control signal to the connection unit 125. The information on gaze directions and the capturing time associated therewith are sequentially transferred to the control unit 126.

Specifically, on the basis of information on a plurality of consecutive gaze directions and capturing time associated therewith, the control unit 126 detects whether the user's gaze point based on the information on the consecutive gaze directions overlaps a display position of a specific object that was being displayed on the display unit 121 at the corresponding capturing time, and a gaze time thereof.

When the control unit 126 detects that a specific object has been gazed for a time t1 (e.g., one second) or more, the control unit 126 generates a control signal for focusing on the specific object and transfers the control signal to the connection unit 125.

When the control unit 126 detects that a specific object has been gazed for a time t2 (e.g., three seconds) or more, the control unit 126 generates a control signal for controlling the external imaging camera 190 to slowly zoom in on the specific object and transfers the control signal to the connection unit 125.

When the control unit 126 detects that a specific object has been gazed for a time t3 (e.g., five seconds) or more, the control unit 126 records a 2D video based on a 3D video displayed on the display unit 121 in a memory (not illustrated) of the head mounted display 100.

Here, the times t1, t2, and t3 may have any lengths different from each other, and there is no hierarchical relation in the lengths thereof. That is, the time t1 may be set as four seconds, and the time t2 may be set as two seconds. However, because a longer gaze time represents a higher interest of the user on a specific object, performing control for performing imaging that allows the user to better understand the specific object as the gaze time is longer is preferable. In the present embodiment, it is assumed that t3>t2>t1 is satisfied.

When the control unit 126 detects that the gaze point is further away from the specific object (the gaze point specified on the basis of the information on gaze directions does not overlap the display position of the specific object) after detecting that the user is gazing at the specific object for a predetermined time or more, the control unit 126 generates a control signal for controlling the external imaging camera 190 to slowly zoom out from the specific object and transfers the control signal to the connection unit 125. Here, when recording the specific object, the control unit 126 gazes at the recording.

The control unit 126 recognizes movement of the eyes of the user on the basis of the captured image transferred from the imaging unit 124. Specifically, when the user closing his or her eyelid for a predetermined number of times (e.g, twice) within a predetermined amount of time (e.g., within one second) is detected on the basis of the captured image, the control unit 126 records a 3D video displayed on the display unit 121 as a 2D image in the memory (not illustrated) of the head mounted display 100. Because the 3D video includes an image for the right eye and an image for the left eye, the control unit 126 records only one of the image for the right eye and the image for the left eye as the 2D image.

The configuration of the head mounted display 100 has been described above.

As illustrated in FIG. 4, the gaze detection device 200 includes a second communication unit 220, a gaze detection unit 221, the video generation unit 222, and a storage unit 223.

The second communication unit 220 is a communication interface having a function of communicating with the first communication unit 118 of the head mounted display 100. As described above, the second communication unit 220 communicates with the first communication unit 118 through wired communication or wireless communication. The second communication unit 220 transmits the image data for displaying the virtual space image transferred from the video generation unit 222, the marker image used for the calibration, and the like to the head mounted display 100. Further, the second communication unit 220 transfers an image including the user's eye gazing the marker image captured by the imaging unit 124 transferred from the head mounted display 100 or an image including the user's eye gazing an image displayed on the basis of the image data output by the video generation unit 222 to the gaze detection unit 221. Further, the second communication unit 220 transfers a video captured by the external imaging camera 190 to the video generation unit 222.

The gaze detection unit 221 receives the image data for detecting a gaze of the right eye of the user from the second communication unit 220 and detects a gaze direction of the user's right eye. The gaze detection unit 221 calculates a right-eye gaze vector indicating the gaze direction of the right eye of the user by using a method which will be described below. Likewise, the gaze detection unit 221 receives the image data for detecting a gaze of the left eye of the user from the second communication unit 220 and calculates a left-eye gaze vector indicating the gaze direction of the left eye of the user 300. Then, the gaze detection unit 221 uses the calculated gaze vectors to specify a point viewed by the user in the image displayed on the image display element 108. Further, the gaze detection unit 221 transmits the calculated gaze vectors as information on gaze directions, together with capturing time information associated with the captured image used for calculating the gaze vectors, to the head mounted display 100 via the second communication unit 220. Further, the information on gaze directions may also be information on a gaze point specified by the gaze detection unit 221.

The video generation unit 222 generates image data to be displayed on the display unit 121 of the head mounted display 100 and transfers the image data to the second communication unit 220. The video generation unit 222 generates, for example, image data for displaying a virtual space image. Alternatively, the video generation unit 222 generates image data by processing an external video captured by the external imaging camera 190 and transferred from the second communication unit 220. Further, the video generation unit 222 generates a marker image for calibration for gaze detection and transfers the marker image together with positions of display coordinates thereof to the second communication unit 220 to transmit the marker image to the head mounted display 100.

The storage unit 223 is a recording medium that stores various programs or data required for operation of the gaze detection device 200. The storage unit 223 is realized by, for example, a hard disk drive (HDD), a solid state drive (SSD), etc.

Next, gaze direction detection according to an embodiment will be described.

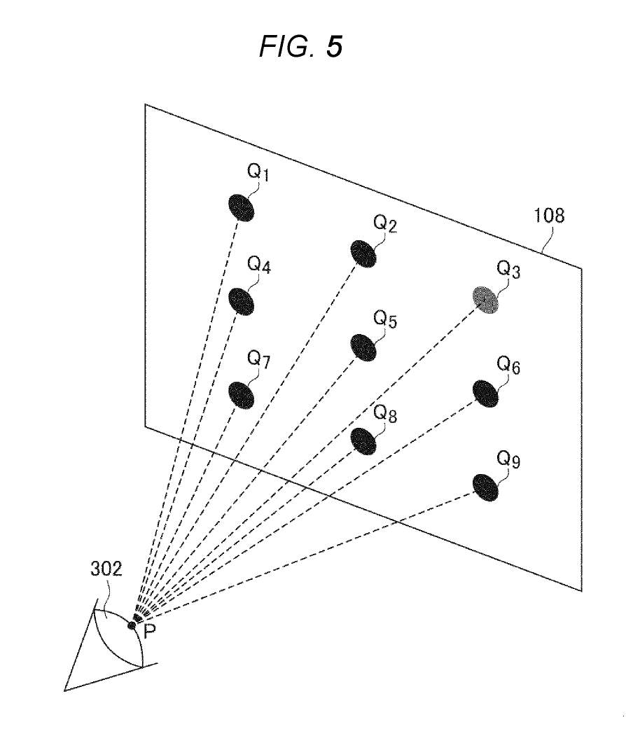

FIG. 5 is a schematic diagram illustrating calibration for detection of the gaze direction according to the embodiment. The gaze direction of the user 300 is realized by the gaze detection unit 221 in the gaze detection device 200 analyzing the video captured by the camera 116 and output to the gaze detection device 200 by the first communication unit 118.

The video generation unit 222 generates nine points (marker images) including points Q₁ to Q₉ as illustrated in FIG. 5, and causes the points to be displayed by the image display element 108 of the head mounted display 100. The gaze detection device 200 causes the user 300 to sequentially gaze at the points Q₁ up to Q₉. In this case, the user 300 is requested to gaze at each of the points by moving his or her eyeballs as much as possible without moving his or her neck. The camera 116 captures images including the cornea 302 of the user 300 when the user 300 is gazing at the nine points including the points Q₁ to Q₉.

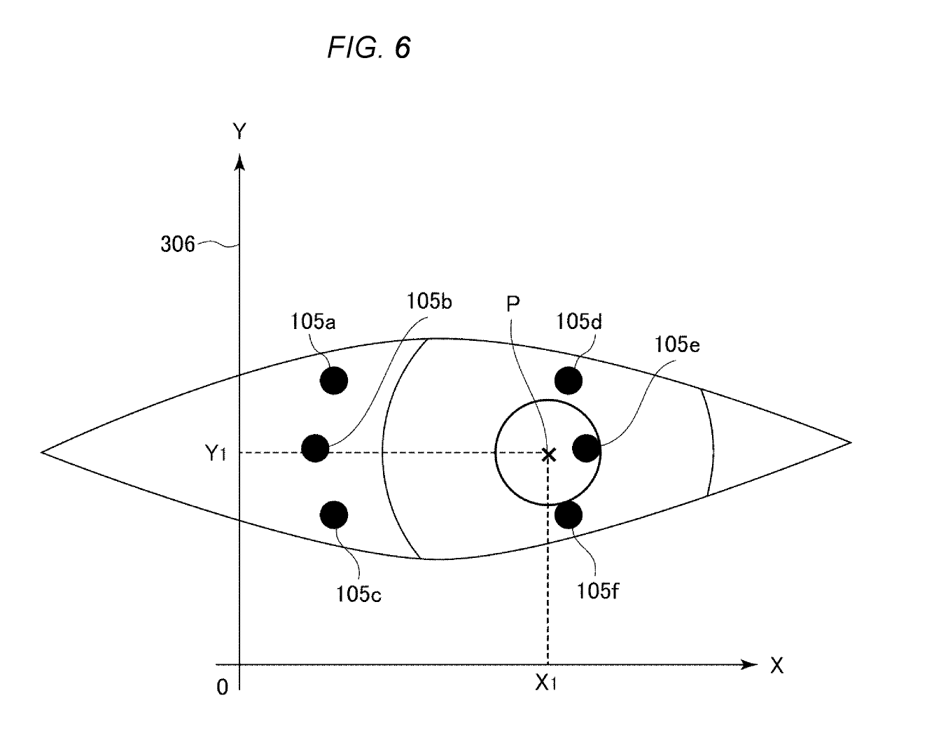

FIG. 6 is a schematic diagram illustrating the position coordinates of the cornea 302 of the user 300. The gaze detection unit 221 in the gaze detection device 200 analyzes the images captured by the camera 116 and detects bright spots 105 derived from the infrared light. When the user 300 gazes at each point by moving only his or her eyeballs, the positions of the bright spots 105 are considered to be stationary regardless of the point at which the user gazes. Thus, on the basis of the detected bright spots 105, the gaze detection unit 221 sets a two-dimensional coordinate system 306 in the image captured by the camera 116.

Further, the gaze detection unit 221 detects the center P of the cornea 302 of the user 300 by analyzing the image captured by the camera 116. This is realized by using known image processing such as the Hough transform or an edge extraction process. Accordingly, the gaze detection unit 221 can acquire the coordinates of the center P of the cornea 302 of the user 300 in the set two-dimensional coordinate system 306.

In FIG. 5, the coordinates of the points Q₁ to Q₉ in the two-dimensional coordinate system set for the display screen displayed by the image display element 108 are Q₁(x1, y1)^{T}, Q₂(x2, y2)^{T}, Q₉(x9, y9)^{T}, respectively. The coordinates are, for example, a number of a pixel located at a center of each point. Further, the center P of the cornea 302 of the user 300 when the user 300 gazes at the points Q₁ to Q₉ are labeled P₁ to P₉. In this case, the coordinates of the points P1 to P9 in the two-dimensional coordinate system 306 are P₁(X1, Y1)^{T}, P₂(X2, Y2)^{T}, P₉(X9, Y9)^{T}. T represents a transposition of a vector or a matrix.

A matrix M with a size of 2×2 is defined as Equation (1) below.

$$M = ( \begin{matrix}{m}_{11} & {m}_{12} \\ {m}_{21} & {m}_{22}\end{matrix} ) \qquad ( 1 )$$

In this case, if the matrix M satisfies Equation (2) below, the matrix M is a matrix for projecting the gaze direction of the user 300 onto an image plane that is displayed by the image display element 108.

P_{N}=MQ_{N}(N=1, . . . ,9) (2)

When Equation (2) is written specifically, Equation (3) below is obtained.

$$( \begin{matrix}{x}_{1} & {x}_{2} & … & {x}_{9} \\ {y}_{1} & {y}_{2} & … & {y}_{9}\end{matrix} ) = ( \begin{matrix}{m}_{11} & {m}_{12} \\ {m}_{21} & {m}_{22}\end{matrix} ) ( \begin{matrix}{X}_{1} & {X}_{2} & … & {X}_{9} \\ {Y}_{1} & {Y}_{2} & … & {Y}_{9}\end{matrix} ) \qquad ( 3 )$$

By transforming Equation (3), Equation (4) below is obtained.

$$( \begin{matrix}{x}_{1} \\ {x}_{2} \\ ⋮ \\ {x}_{9} \\ {y}_{1} \\ {y}_{2} \\ ⋮ \\ {y}_{9}\end{matrix} ) = ( \begin{matrix}{X}_{1} & {Y}_{1} & 0 & 0 \\ {X}_{2} & {Y}_{2} & 0 & 0 \\ ⋮ & ⋮ & ⋮ & ⋮ \\ {X}_{9} & {Y}_{9} & 0 & 0 \\ 0 & 0 & {X}_{1} & {Y}_{1} \\ 0 & 0 & {X}_{2} & {Y}_{2} \\ ⋮ & ⋮ & ⋮ & ⋮ \\ 0 & 0 & {X}_{9} & {Y}_{9}\end{matrix} ) ( \begin{matrix}{m}_{11} \\ {m}_{12} \\ {m}_{21} \\ {m}_{22}\end{matrix} ) \qquad ( 4 )$$

Here,

$$y = ( \begin{matrix}{x}_{1} \\ {x}_{2} \\ ⋮ \\ {x}_{9} \\ {y}_{1} \\ {y}_{2} \\ ⋮ \\ {y}_{9}\end{matrix} ) , A = ( \begin{matrix}{X}_{1} & {Y}_{1} & 0 & 0 \\ {X}_{2} & {Y}_{2} & 0 & 0 \\ ⋮ & ⋮ & ⋮ & ⋮ \\ {X}_{9} & {Y}_{9} & 0 & 0 \\ 0 & 0 & {X}_{1} & {Y}_{1} \\ 0 & 0 & {X}_{2} & {Y}_{2} \\ ⋮ & ⋮ & ⋮ & ⋮ \\ 0 & 0 & {X}_{9} & {Y}_{9}\end{matrix} ) , x = ( \begin{matrix}{m}_{11} \\ {m}_{12} \\ {m}_{21} \\ {m}_{22}\end{matrix} )$$

By the above, Equation (5) below is obtained.

y=Ax (5)

In Equation (5), elements of the vector y are known since these are coordinates of the points Q₁ to Q₉ that are displayed on the image display element 108 by the gaze detection unit 221. Further, the elements of the matrix A can be acquired since the elements are coordinates of a vertex P of the cornea 302 of the user 300. Thus, the gaze detection unit 221 can acquire the vector y and the matrix A. A vector x that is a vector in which elements of a transformation matrix M are arranged is unknown. Since the vector y and matrix A are known, an issue of estimating matrix M becomes an issue of obtaining the unknown vector x.

Equation (5) becomes the main issue to decide if the number of equations (that is, the number of points Q presented to the user 300 by the gaze detection unit 221 at the time of calibration) is larger than the number of unknown numbers (that is, the number 4 of elements of the vector x). Since the number of equations is nine in the example illustrated in Equation (5), Equation (5) is the main issue to decide.

An error vector between the vector y and the vector Ax is defined as vector e. That is, e=y−Ax. In this case, a vector xₒₚₜ that is optimal in the sense of minimizing the sum of squares of the elements of the vector e can be obtained from Equation (6) below.

xₒₚₜ=(A_{T}A)₋₁A_{T}y (6)

Here, “−1” indicates an inverse matrix.

The gaze detection unit 221 forms the matrix M of Equation (1) by using the elements of the obtained vector xₒₚₜ. Accordingly, by using coordinates of the vertex P of the cornea 302 of the user 300 and the matrix M, according to Equation (2), the gaze detection unit 221 may estimate which portion of the video displayed on the image display element 108 the right eye of the user 300 is viewing. Here, the gaze detection unit 221 also receives information on a distance between the eye of the user and the image display element 108 from the head mounted display 100 and modifies the estimated coordinate values of the gaze of the user according to the distance information. The deviation in estimation of the gaze position due to the distance between the eye of the user and the image display element 108 may be ignored as an error range. Accordingly, the gaze detection unit 221 can calculate a right gaze vector that connects a gaze point of the right eye on the image display element 108 to a vertex of the cornea of the right eye of the user. Similarly, the gaze detection unit 221 can calculate a left gaze vector that connects a gaze point of the left eye on the image display element 108 to a vertex of the cornea of the left eye of the user. A gaze point of the user on a two-dimensional plane can be specified with a gaze vector of only one eye, and information on a depth direction of the gaze point of the user can be calculated by obtaining gaze vectors of both eyes. In this manner, the gaze detection device 200 may specify a gaze point of the user. The method of specifying a gaze point described herein is merely an example, and a gaze point of the user may be specified using methods other than that according to this embodiment.

<Operation>

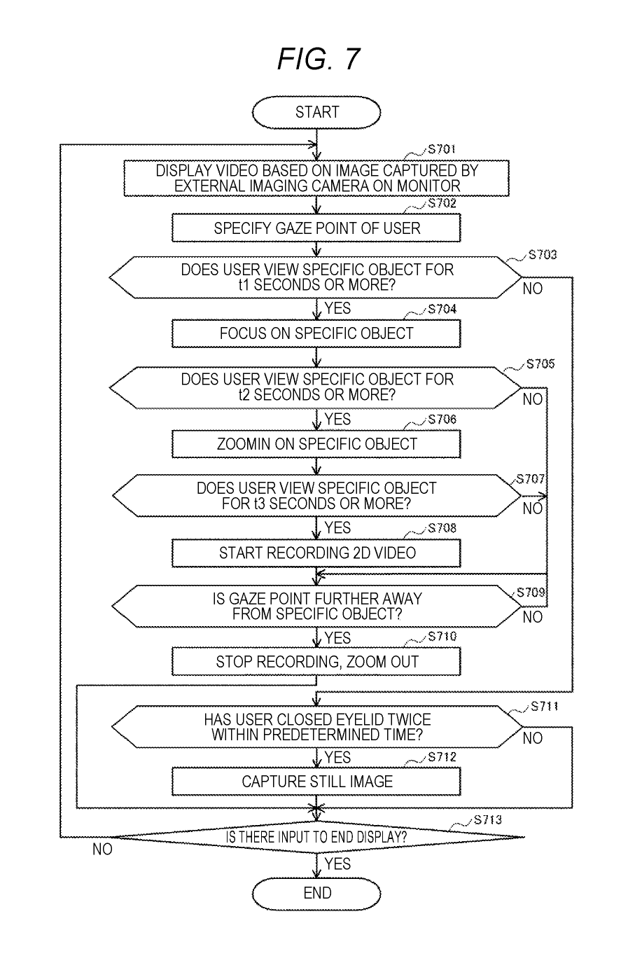

Hereinafter, the operation of the external imaging system 1 according to the present embodiment will be described. FIG. 7 is a flowchart illustrating an operation of the external imaging system 1 and is a flowchart illustrating a process of controlling imaging by the external imaging camera 190 connected to the head mounted display 100.

The head mounted display 100 transmits a captured image of an eye of the user for detecting a gaze direction of the user to the gaze detection device 200 every in a timely manner (e.g., every 0.1 second), and the gaze detection device 200 detects a gaze direction on the basis of the received captured image and transmits the information thereof to the head mounted display 100.

The display unit 121 of the head mounted display 100 displays an image which is generated by the video generation unit 222 of the gaze detection device 200 and is based on a video captured by the external imaging camera 190 (step S701).

The control unit 126 specifies a gaze point of the user in the image displayed on the display unit 121 on the basis of the information on gaze directions transferred from the first communication unit 118 (step S702).

The control unit 126 specifies coordinates at which the user gazes on the basis of information on consecutively transferred gaze directions. The control unit 126 determines whether the user is gazing at a specific object for a predetermined time t1 or more on the basis of capturing time information associated with the information on gaze directions (step S703). When the user is not gazing at the specific object for the predetermined time t1 or more (NO to step S703), the process proceeds to step S711.

When it is determined that the user is gazing at the specific object for the predetermined time t1 or more (YES to step S703), the control unit 126 generates a control signal for the external imaging camera 190 to focus on the specific object and transfers the control signal to the connection unit 125. Thus, imaging by the external imaging camera 190 connected to the connection unit 125 becomes imaging focused on the specific object (step S704).

The control unit 126 determines whether a predetermined time t2 has elapsed after the user gazes at the specific object (step S705). When it is determined that the user is not gazing at the specific object for the predetermined time t2 or more (NO to step S705), the process proceeds to step S709.

When it is determined that the user is gazing at the specific object for the predetermined time t2 or more (YES to step S705), the control unit 126 generates a control signal for zooming in on the specific object at which the user gazes and transfers to control signal to the connection unit 125. Thus, imaging by the external imaging camera 190 connected to the connection unit 125 performs imaging to slowly zoom in on the specific object (step S706).

Next, the control unit 126 determines whether the user is gazing at the specific object for a predetermined time t3 or more (step S707). When it is determined that the user is not gazing at the specific object for the predetermined time t3 or more (NO to step S707), the process proceeds to step S709.

When it is determined that the user is gazing at the specific object for the predetermined time t3 or more (YES to step S707), the control unit 126 starts a recording process with a 3D video displayed on the display unit 121 as a 2D video (step S708).

After that, the control unit 126 determines whether the gaze point of the user is further away from the specific object (step S709). When it is determined that the gaze point of the user is further away from the specific object (YES to step S709), the control unit 126 ends recording when recording of the 2D video has been is progress, generates a control signal for imaging by the external imaging camera 190 to be imaging by slowly zooming out from the specific object, and transfers the control signal to the connection unit 125 (step S710). Thus, the external imaging camera 190 performs imaging while slowly zooming out from the specific object. Then, the process proceeds to step S713.

When it is determined in step S703 that the user is not gazing at the specific object for the predetermined time t1 or more (NO to step S703), the control unit 126 determines whether the user has closed his or her eyelid twice within a predetermined time on the basis of the image captured by the imaging unit 124 (step S711). When it is determined that the user has not closed his or her eyelid twice within the predetermined time (NO to step S711), the process proceeds to step S713.

When it is determined that the user has closed his or her eyelid twice within the predetermined time (YES to step S711), the control unit 126 generates a 2D still image based on the 3D video being displayed on the display unit 121 and stores the 2D still image in a memory.

The control unit 126 determines whether an input to end display on the display unit 121 of the head mounted display 100 is made by the user (step S713). When the input to end display is not received (NO to step S713), the process returns to step S701. When the input to end display is received (YES to step S713), the process ends.

Thus, the external imaging system 1 may perform imaging by controlling the external imaging camera 190 on the basis of a gaze of the user.

### SUMMARY

As described above, the external imaging system 1 according to the present embodiment can control imaging by the external imaging camera 190 connected to the head mounted display 100 according to a gaze direction and a gaze time of a user. For example, when the user is gazing at a specific object for a predetermined time or more, control for auto-focusing on the object can be performed. Therefore, because the user can control imaging just by gazes, a degree of freedom of operation using the head mounted display 100 can be improved.

<Supplement>

The external imaging system according to the present invention is not limited to the above embodiment and may also be realized using other methods to realize the idea of the invention. Hereinafter, other embodiments that may be included as the idea of the present invention will be described.

(1) The control method of the external imaging camera 190 described in the above embodiment is merely an example, and the control unit 126 may perform other control as long as imaging by the external imaging camera 190 is controlled according to a gaze direction of the user and a gaze time thereof.

(2) Although not particularly described in the above embodiment, the external imaging system 1 may further include a controller that can be operated by the user and may perform more detailed control of the external imaging camera 190 in combination with a gaze direction of the user.

(3) The method related to gaze detection in the above embodiment is merely an example, and a gaze detection method by the head mounted display 100 and the gaze detection device 200 is not limited thereto.

First, in the above embodiment, although an example in which a plurality of infrared light sources that emit near-infrared light as invisible light are provided is given, a method of irradiating a user's eye with near-infrared light is not limited thereto. For example, each pixel that constitutes the image display element 108 of the head mounted display 100 may include sub-pixels that emit near-infrared light, and the sub-pixels that emit near-infrared light may be caused to selectively emit light to irradiate an eye of a user with near-infrared light. Alternatively, the head mounted display 100 may include a retinal projection display instead of the image display element 108 and realize near-infrared irradiation by displaying using the retinal projection display and including pixels that emit a near-infrared light color in the image projected to the retina of the user. Sub-pixels that emit near-infrared light may be regularly changed for both the image display element 108 and the retinal projection display. The hot mirror 112 according to the above embodiment is unnecessary in the case in which sub-pixels that emit near-infrared light are provided as sub-pixels in the image display element 108 or the case in which pixels of near-infrared light are included in the retinal projection display.

Further, the gaze detection algorithm given in the above embodiment is not limited to the method given in the above embodiment, and other algorithms may be used as long as gaze detection can be realized.

(4) In the above embodiment, the 2D video recorded in step S708 or the still image captured in step S710 may be transmitted to the gaze detection device 200 and stored in the storage unit 223 of the gaze detection device 200.

(5) In the above embodiment, the external imaging camera 190 may be attached to the head mounted display 100 to be rotatable in up-down and left-right directions by a gear motor. Also, the control unit 126 may control a capturing direction of the external imaging camera 190 according to a gaze direction of a user.

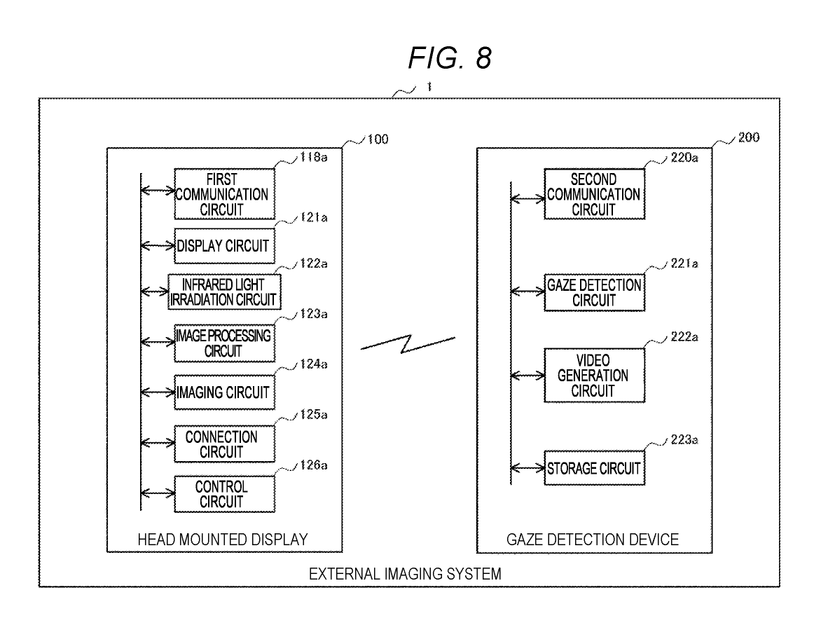

(6) In the above embodiment, although control of the external imaging camera connected to the head mounted display 100 is realized by a processor of the head mounted display 100 and the gaze detection device 200 executing an external imaging program or the like, the control of the external imaging camera may also be performed by a logic circuit (hardware) or a dedicated circuit formed in an integrated circuit (IC) chip, a large scale integration (LSI), or the like of the gaze detection device 200. These circuits may be realized by one or a plurality of ICs, and functions of a plurality of functional parts in the above embodiment may be realized by a single IC. The LSI is sometimes referred to as VLSI, super LSI, ultra LSI, etc. due to the difference in integration degree. That is, as illustrated in FIG. 8, the head mounted display 100 may include a first communication circuit 118a, a first display circuit 121a, an infrared light irradiation circuit 122a, an image processing circuit 123a, an imaging circuit 124a, a connection circuit 125a, and a control circuit 126a, and functions thereof are the same as those of respective parts with the same names given in the above embodiment. Further, the gaze detection device 200 may include a second communication circuit 220a, a gaze detection circuit 221a, a video generation circuit 222a, and a storage circuit 223a, and functions thereof are the same as those of respective parts with the same names given in the above embodiment.

The external imaging program may be recorded in a processor-readable recording medium, and a “non-transient tangible medium” such as a tape, a disc, a card, a semiconductor memory, and a programmable logic circuit may be used as the recording medium. Further, the external imaging program may be supplied to the processor via any transmission medium (a communication network, broadcast waves, or the like) capable of transferring the external imaging program. The present invention can also be realized in the form of a data signal embedded in carrier waves in which the external imaging program is implemented by electronic transmission.

The gaze detection program may be implemented using, for example, a script language such as ActionScript, JavaScript®, Python, or Ruby and a compiler language such as C language, C++, C#, Objective-C, or Java®.

(7) The configurations given in the above embodiment and each (supplement) may be appropriately combined.

This invention can be used in a head mounted display.

1. An external imaging system comprising a head mounted display and a gaze detection device,
wherein the head mounted display includes
an irradiation unit that irradiates an eye of a user with invisible light;
an imaging unit that captures an image including the eye of the user being irradiated by the irradiation unit on the basis of the invisible light;
a first transmission unit that transmits a captured image captured by the imaging unit and capturing time information indicating a capturing time at which the captured image is captured to the gaze detection device;
a first reception unit that receives information on gaze directions of the user from the gaze detection device; and
a connection unit that connects with an external imaging camera,
a display unit that displays an image based on a video captured by the external imaging camera; and
a control unit that controls the external imaging camera,
the gaze detection device includes
a second reception unit that receives the captured image and the capturing time information;
a gaze detection unit that analyzes the captured image to detect the gaze direction of the user; and
a second transmission unit that transmits information on the detected gaze direction to the head mounted display in association with the capturing time of the captured image used in detecting the gaze direction, and
the control unit performs control of imaging by the external imaging camera on the basis of information on a plurality of gaze directions and a gaze time of the user calculated from the capturing time associated with the gaze direction.

2. The external imaging system according to claim 1, wherein, when gazing at a specific object displayed on the display unit for a predetermined time t1 or more is detected, the control unit controls the external imaging camera to focus on the specific object.

3. The external imaging system according to claim 1, wherein, when gazing at a specific object displayed on the display unit for a predetermined time t2 or more is detected, the control unit controls the external imaging camera to zoom in on the specific object.

4. The external imaging system according to claim 1, further comprising a recording unit that records a video captured by the external imaging camera when gazing at a specific object displayed on the display unit for a predetermined time t3 or more is detected.

5. The external imaging system according to claim 2, wherein, when a gaze direction indicated by the information on gaze directions is further away from a specific object, the control unit controls the external imaging camera to zoom out from the specific object.

6. The external imaging system according to claim 1, further comprising a generation unit that generates a still image on the basis of a video captured by the external imaging camera when the user closing his or her eyelid twice within a predetermined time is detected from the video captured by the imaging unit.

7. An external imaging method in which an external video is captured by an external imaging system including a head mounted display to which an external imaging camera for imaging the outside is detachably connected and a gaze detection device, the external imaging method comprising:
a displaying step of displaying an image based on a video captured by the external imaging camera on a display unit;
an irradiating step in which the head mounted display irradiates an eye of a user with invisible light;
an imaging step in which the head mounted display captures an image including the eye of the user being irradiated with the invisible light on the basis of the invisible light;
a first transmitting step of transmitting a captured image captured by the head mounted display and capturing time information indicating a capturing time at which the captured image is captured to the gaze detection device;
a first receiving step in which the gaze detection device receives the captured image and the capturing time information;
a gaze detecting step in which the gaze detection device analyzes the captured image to detect a gaze direction of the user;
a second transmitting step in which the gaze detection device transmits information on the detected gaze direction to the head mounted display in association with the capturing time of the captured image used in detecting the gaze direction; and
a controlling step in which the head mounted display performs control of imaging by the external imaging camera on the basis of information on a plurality of gaze directions and a gaze time of the user calculated from the capturing time associated with the gaze direction.

8. An external imaging program for capturing an external video by a head mounted display in an external imaging system including the head mounted display to which an external imaging camera for imaging the outside is detachably connected and a gaze detection device, wherein the external imaging program allows a computer to execute
a displaying function of displaying an image based on a video captured by the external imaging camera on a display unit;
an irradiating function in which the head mounted display irradiates an eye of a user with invisible light;
an imaging function of imaging an image including the eye of the user being irradiated with the invisible light on the basis of the invisible light;
a transmitting function of transmitting the captured image and capturing time information indicating a capturing time at which the captured image is captured to the gaze detection device;
a receiving function of receiving, from the gaze detection device, information on gaze directions detected by the gaze detection device on the basis of the captured image and the capturing time at which the image used in the detection is captured; and
a controlling function of performing control of imaging by the external imaging camera on the basis of information on a plurality of gaze directions and a gaze time of the user calculated from the capturing time associated with the gaze direction.
